(19) United States
(12) Patent Application Publication
(10) Pub. No.: US 2007/0189380 A1
(43) Pub. Date: Aug. 16, 2007

(54) METHOD AND APPARATUS FOR VIDEO BUFFER VERIFIER UNDERFLOW AND OVERFLOW CONTROL

(75) Inventors: Kwong Huang Goh, Singapore (SG); Hui Y.W. Lucas, Singapore (SG)

Correspondence Address: SEED INTELLECTUAL PROPERTY LAW GROUP PLLC, 701 FIFTH AVE, SUITE 5400, SEATTLE, WA, 98104, US

(73) Assignee: STMICROELECTRONICS ASIA PACIFIC PTE LTD, Singapore (SG)

(21) Appl. No.: 11/674,647

(22) Filed: Feb. 13, 2007

Related U.S. Application Data
(62) Division of application No. 10/466,949, filed on Jan. 5, 2004.

(51) Int. Cl. H04N 11/04; H04N 7/12

(52) U.S. Cl. 375/240.03; 375/240.26

(57) ABSTRACT

A method and apparatus for Video Buffer Verifier (VBV) underflow and overflow control. A combination of picture and slice level control is used in the method and apparatus. Improved prevention of overflow and panic mode encoding is achieved by adjusting the virtual buffer-fullness which allows the quantization-step to have an improved response to the buffer-fullness at both high and low critical levels. The use of a non-linear quantization scheme and customised quantization matrices also provide improved prevention of panic mode encoding. The slice level control also reduces the computation complexity compared to the macroblock level control.

### TECHNICAL FIELD

The present invention relates to Video Buffer Verifier (VBV) control of a video encoder, and in particular, to the efficient prevention of VBV underflow and overflow during MPEG-2 video encoding.

### BACKGROUND ART

VBV Constraints in MPEG-2

The MPEG-2 coded bitstreams are required to meet the constraints imposed by the Video Buffer Verifier (VBV). The VBV is provided with an input buffer known as the VBV buffer which is conceptually used to simulate the entering and removing of coded data to and from a decoder's buffer.

Typically, constraints are imposed which require the entering and removing of the coded data so that the VBV buffer does not overflow or underflow. These constraints are used to guarantee that the decoder buffer will not overflow or underflow.

A virtual VBV buffer is maintained in the encoder and its buffer-fullness is updated to emulate the buffer-fullness in the decoder (refer to FIG. 1). Buffer overflow arises when a picture consumes too few bits while the decoder is nearly full. The bits which arrive at the decoder during the next picture period will then cause an overflow. Note that this overflow constraint applies only to the constant bit-rate application. Buffer underflow occurs when a picture generates too many bits. The constraints of underflow and overflow are considered separately.

VBV buffer-fullness, VBV_fullnessₜ, where t is the picture period, is updated after encoding one picture as follows:
VBV_fullnessₜ=VBV_fullnessₜ−S (1)

where S is the number of bits used for the encoded picture.

At this point, the MPEG-2 underflow constraint states that after the above buffer-fullness update, the buffer-fullness shall not be less than zero:
VBV_fullnessₜ>=0 (2)

The VBV buffer is then filled with the average number of bits per picture, Bpp, which is Bit_rate divided by frame_rate (for variable bit-rate operation, the maximum bit-rate is used to calculate Bpp):
VBV_fullnessₜ₊₁=VBV_fullnessₜ+Bpp (3)

and at this point, the overflow constraint specifies that for a constant bit-rate operation the VBV buffer shall not be greater than the VBV buffer size:
VBV_fullnessₜ₊₁<≦VBV_buffer_size (4)

Details of the VBV specifications can be found in Annex C of the Recommendation ITU-T H.262 (ISO 13818-2 MPEG-2) the disclosures of which are herein incorporated by reference.

MPEG2 TM-5 Rate Control

In the MPEG-2 Test Model-5 (TM-5) of an MPEG-2 video encoder, “virtual buffer-fullness”, is used to determine the reference quantization parameter. Before encoding macroblock j (j>=1), the fullness of the appropriate virtual buffer is computed:
dⱼⁱ=d₀ⁱ+Bⱼ−1−Tᵢ(j−1)/MB_cnt
or
dⱼ^{p}=d₀^{p}+Bⱼ−1−Tₚ(j−1)/MB_cnt
or
dⱼ^{b}=d₀^{b}+Bⱼ−1−T_{b}(j−1)/MB_cnt

depending on the picture type,

where,

d₀ⁱ, d₀^{p}, d₀^{b} are initial fullness of virtual buffers—one for each picture type; Bⱼ is the number of bits generated by encoding all macroblocks in the picture, up to and including j;

MB_cnt is the number of macroblocks in the picture; and

dⱼⁱ, dⱼ^{p}, dⱼ^{b} are the fullness of virtual buffers at macroblock j—one for each picture type.

The final fullness of the virtual buffer (dⱼⁱ, dⱼ^{p}, dⱼ^{b}: J=MB_cnt) is used as d₀ⁱ, d₀^{p}, d₀^{b} for encoding the next picture of the same type.

The reference quantization parameter Qⱼ for macroblock j is then computed as follows:
Qⱼ=(dⱼ* 31)/r

where the “reaction parameter” r is given by
r=2* bit_rates/picture_rate

and dⱼ is the fullness of the appropriate virtual buffer.

The initial value for the virtual buffer-fullness is:
d₀ⁱ=10*r/31
d₀^{p}=Kₚ d₀ⁱ
d₀^{b}=K_{b} d₀ⁱ

where Kₚ and K_{b} are “universal” constants dependent on the quantization matrices.

VBV Control

It is to be noted that the following prior art relating to VBV buffer overflow and underflow control algorithm descriptions are typically performed prior to encoding a picture, and after the VBV buffer-fullness rises by Bpp.

Underflow Control

In typical VBV underflow control, such as that disclosed in U.S. Pat. No. 5,650,860, two levels of control are performed. First, the picture level, and then, the macroblock level.

To control buffer underflow in picture level, the target bit T for the next picture is adjusted when necessary such that it does not lead to underflow:
VBV_fullness−T>=0 (5)

In addition to the picture-level preventing of buffer underflow, macroblock (MB) level control is utilised by means of defining a level above the “VBV_fullness=0” level named the “panic level”. If the VBV_fullness should fall below this level, then the encoder will enter “panic mode”. In this mode, only the minimum amount of data to maintain the integrity of the bitstream will be transmitted. In the panic mode all DCT coefficients and all motion vectors are set to zero, thereby generating a minimal amount of conforming encoded data.

To detect this panic level, macroblock (MB) level updating of VBV buffer-fullness is therefore required. The VBV_fullness is updated after encoding each MB:
VBV_fullness=VBV_fullness−s_{mb} (6a)
if (VBV_fullness<panic-level)→Enter Panic mode coding (6b)

where S_{mb} is the number of bits used to encode the macroblock. The encoder will enter the panic mode coding when VBV buffer-fullness is less than panic level.

Overflow Control

As disclosed in U.S. Pat. No. 5,650,860, to avoid VBV overflow, adding zero “stuffing bits” to the bitstream is utilised, when VBV overflow occurs after encoding a picture. However, instead of simply stuffing bits to the bitstream which is considered a waste, the encoder may first determine, prior to encoding a picture, if there are “extra bits”, and add a value extra_bits to the target bits, T, to increase the bits used for the current picture that is to be encoded, which is given by:
extra_bits=VBV_fullness−T+Bpp−VBV_buffer_size (7)
If (extra_bits>0) then T=T+extra_bits (8)

After encoding the current picture, only the necessary number of filling bits are added to the bitstream.

It has been found that the picture-level overflow control is unable to prevent VBV buffer overflow effectively when a sequence switched from a high level of motion (having lots of scene-changes) to a low level of motion. One of the reasons is that the assumption used in equation (7) is not true most of the time.

Equation (7) assumes that the bits used for coding the current picture is equal to the target bits allocated T to forecast the amount of extra_bits required. This assumption is generally not true which is why the prediction of overflow at picture level is quite poor.

Another reason is that the quantization-step which is quite high during a “fast” sequence does not “react” or reduce fast enough when there is a sudden change to a “slow” sequence, therefore generating insufficient bits and causing the VBV buffer to overflow.

If a sequence of pictures are to difficult to encode at a given bit-rate (for example due to a very noisy and action-packed sequence or a synthetic sequence with lots of scene-changes coded at a low bit-rate), when even the maximum quantization-step is used and still could not be sustained at the given low bit-rate, the VBV buffer will reach the panic level.

The prior art prevention method of adjusting the target bits allocation T at picture level is not able to control bits in the VBV buffer when encoding a difficult sequence at a low bit-rate. Using the target bits allocated T to judge the potential of underflow is also not effective.

In panic mode encoding all DCT coefficients are set to zero, the intra-coded macroblocks will appear as “grey-level” blocks subsequently followed by B and P pictures which could be quite irritating, subjectively, to a user.

This identifies a need for a new type of Video Buffer Verifier (VBV) control of a video encoder which overcomes the problems inherent in the prior art.

### DISCLOSURE OF INVENTION

In a preferred embodiment, the present invention seeks to provide improved prevention of panic mode encoding, improved underflow and overflow prevention, and improved quality of video. This is sought to be achieved by implementing additional picture and slice level controls which include:
1) Virtual buffer fullness control (d₀);
2) Quantization-step range control (linear/non-linear quantization); and/or
3) Optional quantization matrices modification.

As macroblock level control is generally required in the panic mode detection and this control has higher implementation costs, it is also sought to be provided by the present invention that the complexity of VBV control is reduced by using slice level control instead of MB level control.

The present invention further seeks to provide a method for Video Buffer Verifier (VBV) control of a video encoder, whereby picture and/or slice level controls are implemented in the method, said picture and/or slice level controls including:

virtual buffer fullness control for increasing the sensitivity of a Q-step; and/or

quantization-step range control for increasing the range of the Q-step.

The present invention also seeks to provide a method wherein, the method additionally includes quantization matrices modification for the prevention of panic mode coding.

Preferably, slice level control is used in place of an MB level control.

In a broad form, the present invention provides that the method results in improved prevention of an underflow or an overflow.

In a further broad form, the present invention provides that the method results in improved encoding at a low bit-rate.

Preferably, the video encoding is MPEG-2 video encoding.

The present invention according to one aspect seeks to provide a method which includes the following steps:

at the picture level control:

updating the VBV buffer-fullness in at least one VBV Update module before at least one Potential Overflow Check module;

reducing the virtual buffer-fullness and increasing the target bit allocation in a Decrease Virtual Buffer-Fullness and Increase Bit Allocation module;

if there is an underflow potential, then according to that underflow potential level: reducing a target bit T in a Decrease Bit Allocation module; increasing quantization range in an Increase Quantization Range module; and/or modifying the quantization matrices and reducing the virtual buffer-fullness in a Modify Q-Matrices and Decrease Virtual Buffer-Fullness module;

at the slice level control:

estimating the VBV buffer-fullness in a VBV Estimation module;

checking for an overflow potential in a Potential Overflow Check module;

if an overflow potential is found, decreasing the virtual buffer-fullness in a Decrease Virtual Buffer-Fullness

for underflow control, updating the slice level VBV in a VBV Update module;

performing a potential underflow check in a Potential Underflow Check module;

after determination of the underflow potential level: increasing the virtual buffer-fullness in an Increase Virtual Buffer-Fullness module; and/or setting the panic mode coding in a Set Panic Mode Coding module; and

encoding a slice in an Encode a Slice module.

In a further broad form of the present invention, the present invention also seeks to provide that the method assists in panic mode coding prevention by addition of a preventive margin to a target bits factor T.

In another preferred form of the invention it is sought to provide that a variable panic level may be used.

The present invention according to another aspect seeks to provide a method wherein, for constant bit-rate coding: at the picture level:

overflow prediction is rendered more sensitive by incorporating a factor dependent on the encoding bit-rate; and

reducing the virtual buffer-fullness when a factor extra-bits is greater than 0;

at the slice level:

estimating the VBV buffer-fullness in each slice and reducing the virtual buffer-fullness if required.

Also preferably, specified levels of buffer-fullness are experimentally determined for each picture type.

In a specific embodiment of the present invention, values of Th1, Th2 and T3 are 200 000, 150 000 and 100 000 respectively for a PAL picture.

In a further embodiment of the present invention there is provided an apparatus for Video Buffer Verifier (VBV) control of a video encoder, whereby the apparatus contains integrated picture and/or slice level controls, said picture and/or slice level controls including:

a virtual buffer-fullness control for increasing the sensitivity of a Q-step; and/or

a quantization-step range control for increasing the range of the Q-step.

Broadly, the apparatus additionally includes quantization matrices modification for the prevention of panic mode coding.

In accordance with a specific embodiment of the present invention there is provided apparatus which at the picture level includes:

at least one VBV Update module;

at least one Potential Overflow Check module;

a Decrease Virtual Buffer Fullness and Increase Bit Allocation module;

a Decrease Bit Allocation module;

an Increase Quantization Range module; and

a Modify Q-Matrices and Decrease Virtual Buffer-Fullness module; and at the slice level said apparatus includes:

a VBV Estimation module;

a VBV Update module;

a Potential Overflow Check module;

a Potential Underflow Check module;

a Decrease Virtual Buffer-Fullness module;

an Increase Virtual Buffer-Fullness module;

a Set Panic Mode Coding module; and

an Encode a Slice module.

In another preferred form of the invention there is provided a method for Video Buffer Verifier (VBV) control of a video encoder, substantially according to the method described in the specification with reference to the accompanying figures.

In another preferred form of the invention there is provided an apparatus for Video Buffer Verifier (VBV) control of a video encoder, substantially according to the embodiment described in the specification with reference to and as illustrated in the accompanying figures.

### BRIEF DESCRIPTION OF FIGURES

The present invention will become apparent from the following description, which is given by way of example only, of a preferred but non-limiting embodiment thereof, described in connection with the accompanying figures, wherein:

FIG. 1 illustrates a preferred embodiment of the present invention wherein, the figure shows an illustration of how a VBV buffer is updated.

FIG. 2 illustrates a preferred embodiment of the present invention wherein, the figure shows a block diagram illustrating picture and slice level VBV control.

FIG. 3 illustrates a preferred embodiment of the present invention wherein, the figure shows a detailed flow diagram the picture and slice level VBV buffer underflow and overflow control.

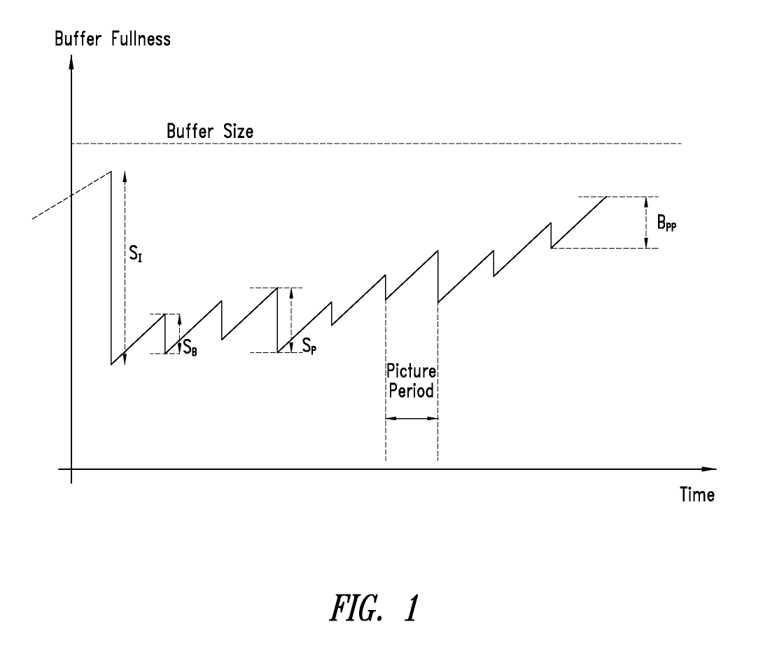

### MODES FOR CARRYING OUT THE INVENTION

In a particular embodiment, the present invention is directed to the prevention of VBV underflow and overflow during MPEG-2 video encoding.

Underflow Control

Picture Level:

The basic step in underflow and panic mode coding prevention is the reducing of the target bits T when necessary. The target bits T in equation (5) are replaced by (T+PM) where PM is defined as the preventive margin to take care of the additional bits that might be used to encode the next picture.

Apart from adjusting the target bits T, additional picture level prevention steps can be used.

A further preventive step is to increase the range of the quantization-step (Q-step) to be used, for example the MPEG-2 non-linear quantization scheme allows the quantization-step to go up to 112. This is used when a potential of panic mode occurrence is detected

A still further preventive step which may be optionally employed is to use customised quantization matrices which are of higher values than the default Q matrix, when a higher potential of panic mode encoding is detected.

Slice Level:

Instead of using the MB level of updating and checking panic level encoding, slice level is used to reduce computation requirements and the potential of panic mode coding of individual MB.

Slice level underflow control for panic mode detection and prevention is performed after encoding each slice of a picture. A Variable Panic Level (VPL) may be used. The VPL varies according to the number of remaining slices (j) to be coded. The slice panic level is made variable depending on the remaining number of slices yet to be encoded to further optimise the VBV control such that the encoder does not go into the panic mode prematurely.

In addition, a slice level adjustment of the virtual buffer-fullness, d₀, (described hereinbefore and in the rate-control of MPEG-2 TM-5) is performed when necessary. When there is a potential of panic mode encoding, the value of d₀ (one for each picture-type) is increased to ensure that the quantization-step (which is computed based on the value of dⱼ) can reach the maximum value in a shorter time interval.

Overflow Control (for Constant Bitrate Coding Only)

Picture Level:

As hereinbefore discussed, the picture level overflow prediction described in equations (7) and (8) is not effective. To render the prediction more sensitive, the value of T in equation (8) is replaced by a value P which depends on the encoding bit-rate of the encoder.

In addition, the virtual buffer fullness do is reduced when extra_bits in equation (8) is greater than 0, in an attempt to reduce the Q-step more rapidly during the encoding of next picture.

Slice Level:

The VBV buffer-fullness is estimated in each slice to check if the VBV buffer is going to be filled up, and d₀ is further reduced if necessary.

### MORE DETAILED DESCRIPTION

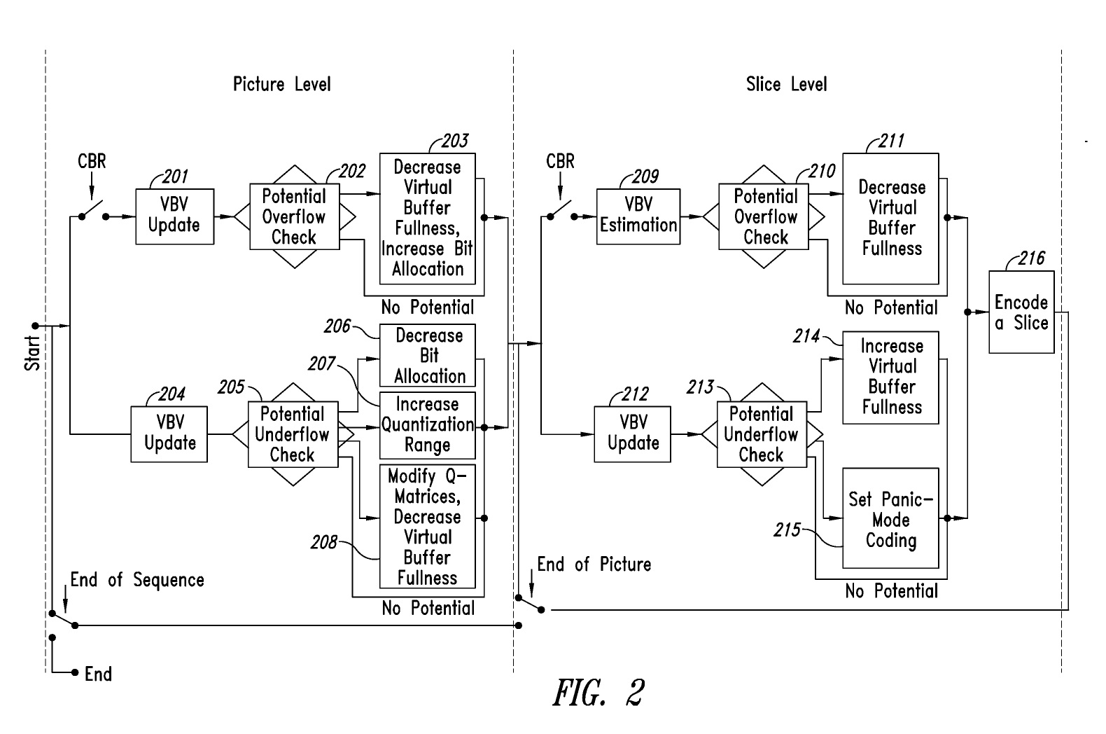

A preferred, but non-limiting, embodiment of the present invention is shown in FIG. 2. This figure shows the block diagram of the apparatus in accordance with the picture and slice level VBV control of the present invention. Note that overflow control is generally only carried out for constant bit-rate encoding.

At the picture level control, the VBV buffer-fullness is updated in the VBV Update modules 201 and 204 before the potential overflow and underflow check modules 202 and 205 respectively.

The virtual buffer-fullness d₀ is reduced and the target bit allocation is increased in module 203 if there is an overflow potential. If there is an- underflow potential, according to the underflow potential level, one or more actions including reducing target bit T (module 206); increasing quantization range (module 207); and modifying the quantization matrices and reducing the virtual buffer fullness (module 208) are carried out.

At slice level (a row of MB), the VBV buffer-fullness is estimated in module 209. If an overflow potential is found in module 210, virtual buffer-fullness d₀ is decreased in module 211. For underflow control, the slice level VBV update is performed in module 212 and the potential underflow check is performed in module 213.

Depending on the underflow potential level, actions are taken in module 214 to increase the virtual buffer fullness d₀ and in module 215 to set the panic mode coding.

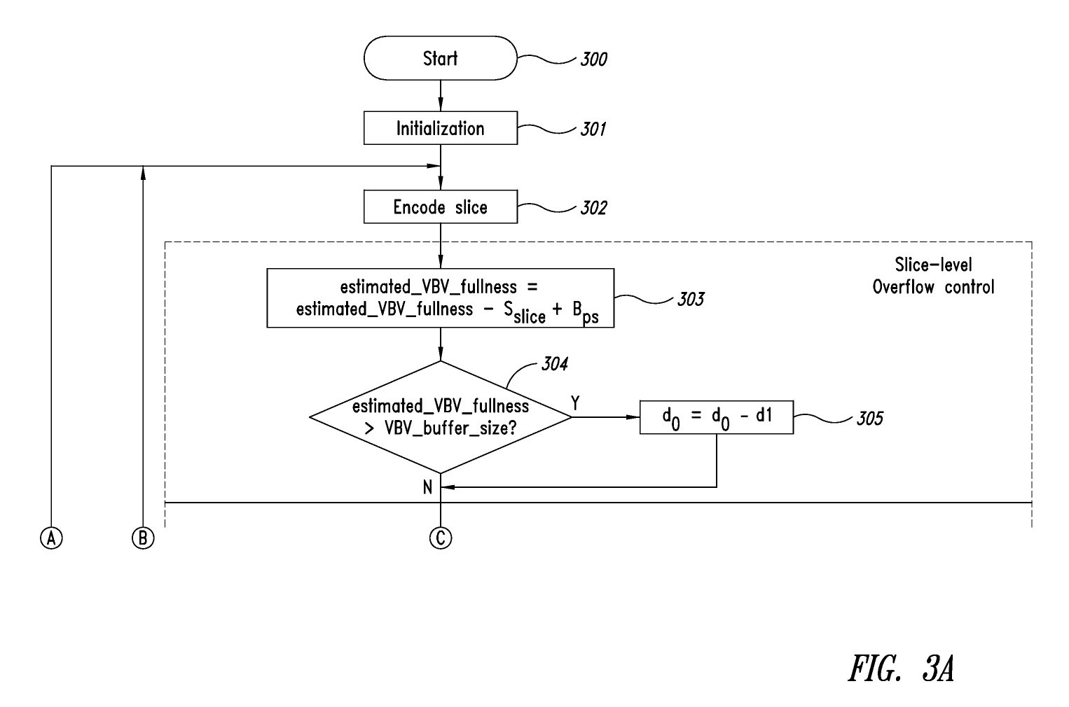

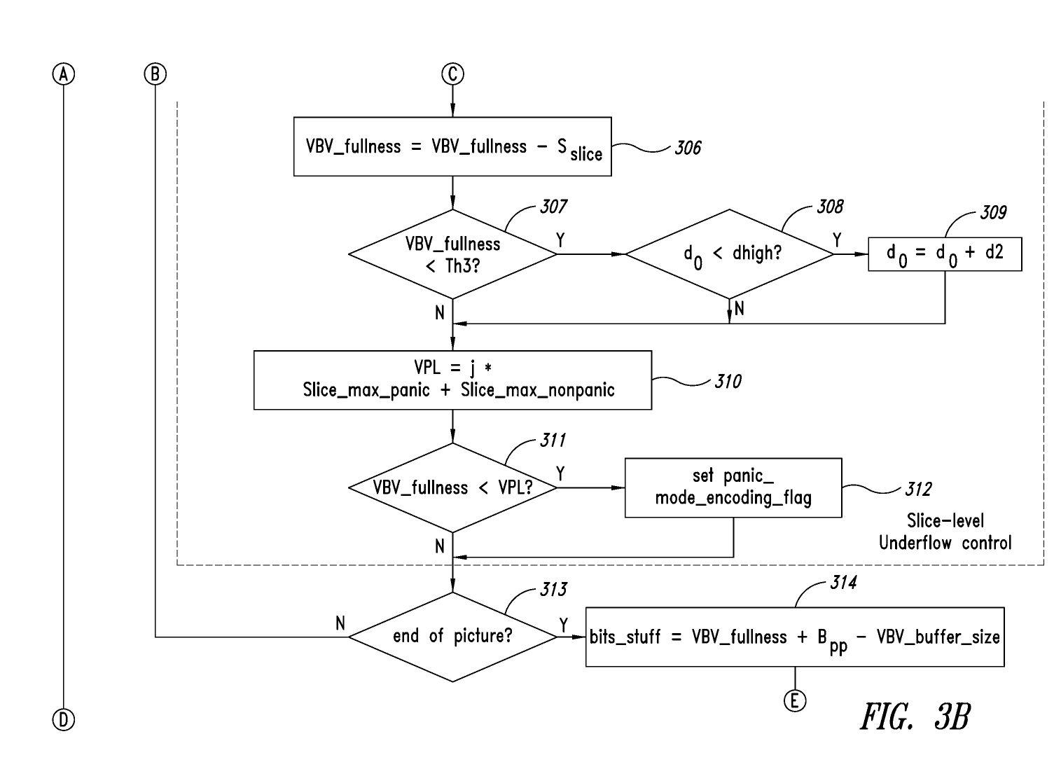

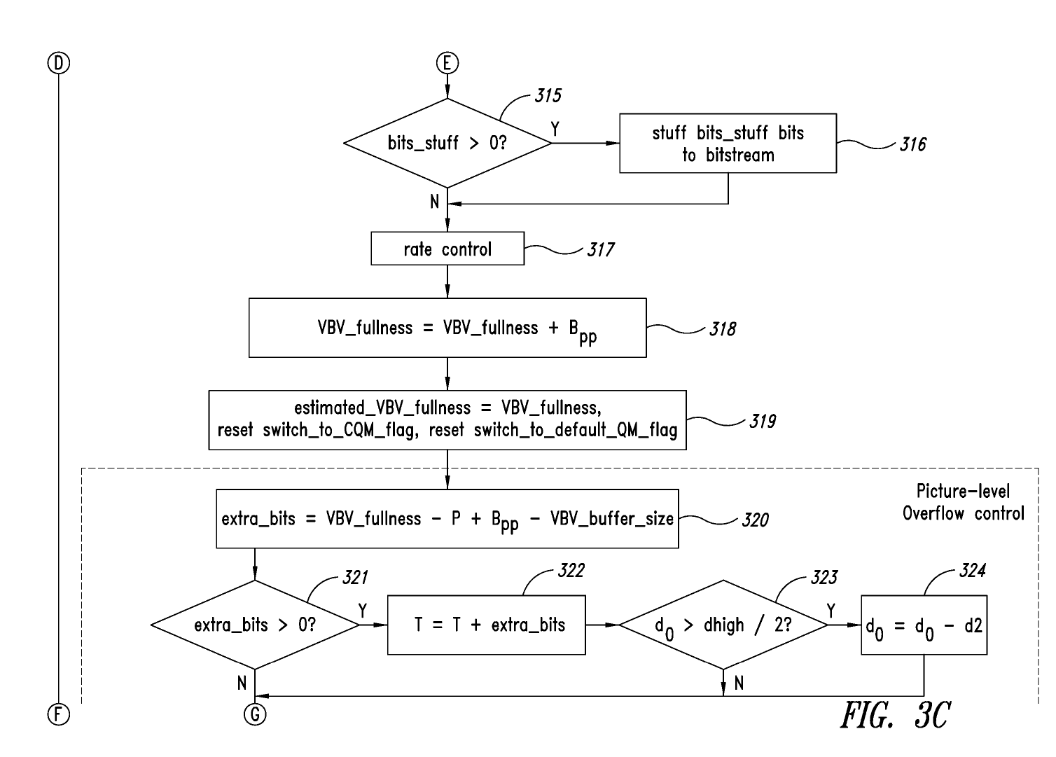

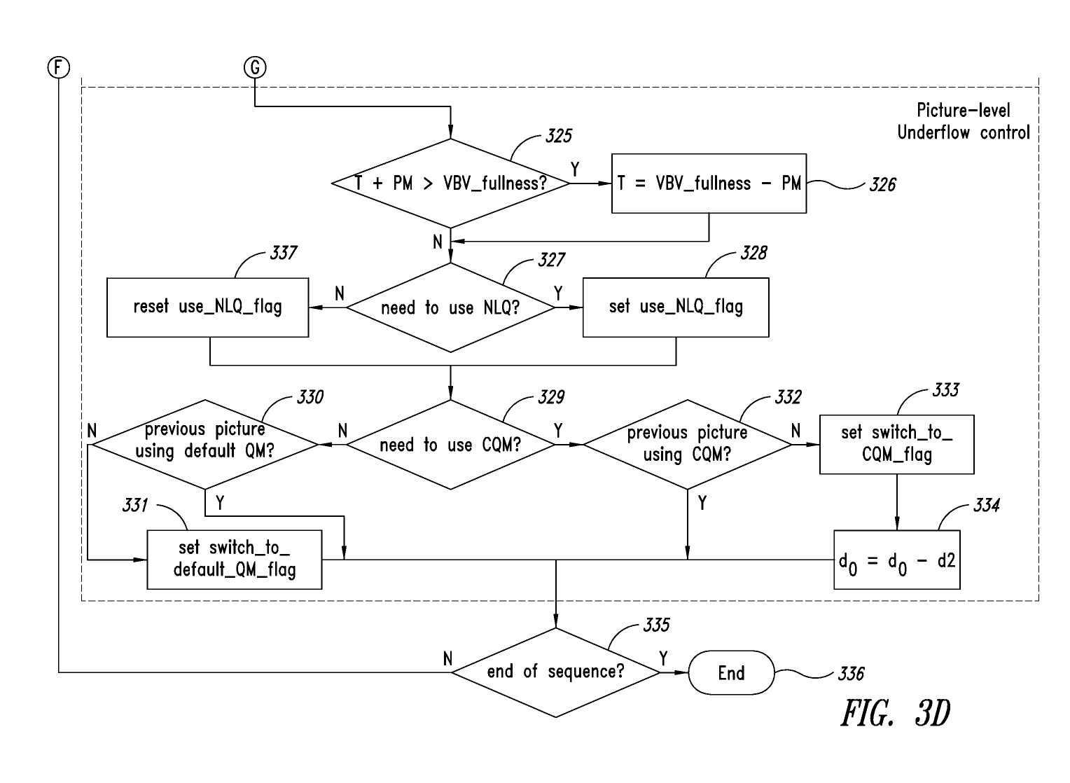

FIG. 3 shows an example of the detailed flow diagram of the picture and slice level underflow and overflow control. The rate control in module 217 is a rate control which uses the virtual buffer-fullness dⱼ for determination of quantization-step, such as in the MPEG-2 TM-5.

Picture Level Control:

For picture level overflow control, before encoding each picture, possible extra_bits is computed in module 320 and checked in module 321 as to whether the target bits T need to be increased in module 322:
extra_bits=VBV_fullness−P+Bpp−VBV_buffer_size (9)

The value of P is set depending on the encoding bit-rate, for example, ¼*Bpp.

If the target bits are required to be increased by extra_bits, which indicates that the VBV buffer is about to overflow, the value of d₀ is reduced by a value d2 in module 324 if it is found to be greater than dhigh/2 in module 323. This is to allow the Q-step to reduce fast enough when an overflow is likely in a situation such as sudden changes in motion activities from very fast to very slow.

In picture level underflow control, the target bits T is first adjusted if necessary in module 326:
if ( (T+PM)>VBV_fullness) then T=VBV_fullness−PM (10)

Setting a small PM value might not be enough to take care of the bits-used discrepancy, and setting a high PM might cause “over-reaction” or unnecessary adjustment in target bit T. The value of PM used is typically experimentally determined, for example a value equal to Bpp is often found to be suitable.

If a sequence of pictures are to difficult to encode at a given bit-rate, when even the maximum quantization-step (Qmax=62 for MPEG-2 linear quantization scheme) is used and still could not be sustained at the given low bit-rate, the VBV buffer will reach the panic level.

To prevent this from happening, the non-linear quantization (NLQ) scheme which allows the Q value to reach a higher maximum value (Qmax_non_linear=112 in MPEG-2) is used (module 328). The decision of when to use NLQ (module 327) can be made by means of checking if the VBV buffer-fullness reaches a specified low level, Th1:
if (VBV_fullness<Th1)→use non-linear quantization scheme else→use linear quantization scheme

Or, by means of checking whether the average Q-step of the picture has reached its maximum:
if (Qmean>=Qmax_linear)→use non-linear quantization scheme else→use linear quantization scheme

If using this NLQ is still not enough to cause the buffer-fullness to drop further, the optional customised inter and intra quantization matrix (which have larger values than the default Q-matrix) are then used in an effort to prevent the buffer fullness level from entering the panic level. The decision of when to use the customised Q-matrix (CQM) in module 329 can be made by means of checking if the buffer-fullness reaches an even lower level at T2:
if (VBV_fullness<Th2)→use customised inter & intra Q-matrices else→use default Q-matrices

Or, by means of checking whether the average non-linear Q-step of the picture has reach its maximum:
if (Qmean==Qmax_non_linear)→use customised inter & intra Q-matrices else→use default Q-matrices

When switching from the default Q-matrix to the customised Q-matrix (module 333), the value of d₀ is reduced in module 334 by a value d2 to allow the Q-steps to have some room for adjustment.

In a preferred embodiment of the present invention, the values of Th1, Th2 and Th3 are experimentally determined as 200 000, 150 000 and 100 000 respectively for PAL picture. The optional customised Q-matrices are scaled versions of the default Q-matrices. The scaling factor used is 1.25 for Intra-Q-matrix and 1.5 for Inter-Q-matrix. It should be appreciated that these values may be varied if desired.

Slice Level Control:

To ensure that no overflow bits are wastefully stuffed, slice level VBV buffer-fullness estimation is performed. Before encoding the current picture, the estimated_VBV_fullness is first initialised in module 319. After encoding each slice, the estimated_VBV_fullness is updated in module 303:
estimated_{—}VBV_fullness=estimated_{—}VBV_fullness−S_{slice}+Bₚₛ (11a)

where S_{slice} is the number of bits used to encode the slice and Bₚₛ, is the average number of bits per slice (Bpp/number_of_slice_per_picture). The value d₀ is further reduced in module 305 at slice level if it is found in module 304 that the estimated_VBV_fullness exceeds the buffer size, VBV_buffer_size, so as to further increase the bits used in encoding the next slice.
if (estimated_{—}VBV_fullness>VBV_buffer_size) d₀d₀−d1 (11b)

For underflow control, the estimated VBV buffer-fullness is updated in module 306:
VBV_fullness=VBV_fullness−S_{slice} (12)

where S_{slice} is the number of bits used to encode the current slice. Note that S_{slice} includes the bits used for encoding the picture header for the first slice. If the VBV buffer-fullness is found in module 307 to be lower than threshold Th3, the value of d₀ is increased in module 309 by a value d2 to ensure that the quantization-step can reach the maximum value quicker, if it is found in module 308 that it has not reach its upper limit dhigh.

A variable panic level (VPL) which is defined as:
VPL=j*Slice_max_panic+Slice_max_nonpanic (13)

is computed in module 310. The VPL varies according to the number of remaining slices, j, to be coded. The Slice_max_panic is the maximum number of bits required to encode a slice in the panic mode and the Slice_max_nonpanic is the maximum number of bits required to encode a slice in the non-panic mode but at the maximum quantization-step.

The slice panic level is made variable depending on the remaining number of slices yet to be encoded to make the VBV control more optimal such that the encoder does not go into the panic mode prematurely. A panic mode encoding flag is set in module 312 as an indication to the encoder, if it is found in module 311 that the VBV_fullness goes below the VPL.

The values of d1, d2 and dhigh are experimentally determined and suitable values are 50 000, 100 000 and 500 000 respectively.

The values of Slice_max_nonpanic and Slice_max_panic are chosen carefully to guarantee that no underflow will occur. The values are experimentally determined and may vary according to the picture type and picture size. An example value for Slice_max_nonpanic is 10 000, and example values for Slice_max_panic are 2000 for I-picture and 150 for P and B pictures.

After the picture is encoded, bits_stuff is computed in module 314 and checked in module 315, if there are bits-stuffing module 316 is required. Rate control and bit-allocation is then performed in module 317 and the VBV buffer-fullness is then updated in module 318.

The preferred embodiment of the present invention performs well in terms of picture quality and buffer-fullness control. The additional picture and slice level overflow and underflow control provide improvements over the prior art, especially in terms of panic mode prevention and overflow prevention. Panic mode encoding has been avoided even for very difficult sequence coding at very low bit-rate. Slice level underflow control is used in place of MB level control and the complexity requirements are reduced as well as individual MB panic mode coding avoided.

VBV buffer overflow is also avoided when encoding video sequences which switch from a high level of motion (having lots of scene-changes) to a low level of motion, which demonstrates that the quantization-step is able to respond quickly enough to the changes.

Thus, there has been provided in accordance with the present invention, a Video Buffer Verifier (VBV) control of a video encoder which satisfies the advantages set forth above.

The invention may also be said broadly to consist in the parts, elements and features referred to or indicated in the specification of the application, individually or collectively, in any or all combinations of two or more of said parts, elements or features, and where specific integers are mentioned herein which have known equivalents in the art to which the invention relates, such known equivalents are deemed to be incorporated herein as if individually set forth.

Although the preferred embodiment has been described in detail, it should be understood that various changes, substitutions, and alterations can be made herein by one of ordinary skill in the art without departing from the scope of the present invention as hereinbefore described and as hereinafter claimed.

1.-17. (canceled)

18. A method comprising:
encoding a slice of video data;
performing slice-level overflow control of the video data for a video buffer;
performing slice-level underflow control of the video data for the video buffer by implementing a variable panic level, the variable panic level varying according to a number of remaining slices to be encoded;
performing picture-level overflow control of the video buffer; and
performing picture-level underflow control of the video buffer.

19. The method as claimed in claim 18, wherein performing the slice-level overflow control of the video data for the video buffer comprises:
estimating a video buffer fullness value after encoding the slice;
using the estimated video buffer fullness value to determine whether there is potential for overflow of the video buffer; and
decreasing the video buffer fullness value if it is determined that there is potential for overflow of the video buffer.

20. The method as claimed in claim 18, wherein performing the slice-level underflow control for the video buffer comprises:
updating a video buffer fullness value after encoding the slice;
increasing a buffer fullness value if the updated video buffer fullness value is less than a configured threshold and if the video buffer fullness value is less than a configured maximum value;
using the variable panic level and updated video buffer fullness value to determine whether there is potential for underflow of the video buffer; and
setting panic mode encoding if it is determined that there is potential for underflow of the video buffer.

21. The method as claimed in claim 18, wherein performing the picture-level overflow control of the video buffer includes:
computing an extra bits value, the extra bits value based at least in part on an encoding bit rate of the video encoder;
increasing a target bits value by adding the extra bits value to the target bits value if the extra bits value is greater than zero; and
decreasing a video buffer fullness value if the extra bits value is greater than zero.

22. The method as claimed in claim 21, wherein performing the picture-level underflow control of the virtual video buffer comprises:
determining whether there is potential for underflow of the video buffer, wherein the determining is based at least in part on whether a sum of the target bits value and a preventative margin exceeds the video buffer fullness value;
decreasing the target bits value if it is determined that there is potential for underflow of the video buffer;
determining whether there is continued potential for underflow of the video buffer; and
if there is continued potential for underflow of the video buffer,
using non-linear quantization; and/or
using a customized quantization matrix with a decreased buffer fullness value.

23. The method of claim 18 wherein performing the slice-level overflow control comprises performing the slice-level overflow control after encoding the slice.

24. The method of claim 18 wherein performing the slice-level underflow control comprises performing the slice-level underflow control after encoding the slice.

25. The method of claim 18 wherein the video buffer is a virtual video buffer.

26. The method of claim 18 wherein the encoding of video data is MPEG-2 video encoding.

27. An apparatus for Video Buffer Verifier (VBV) control of a video encoder, the apparatus comprising:
picture level control means for controlling a virtual buffer fullness;
means for controlling a quantization-step at the picture level;
means for detecting presence of panic mode conditions;
means for modifying quantization matrices under panic mode conditions;
a slice level control means for controlling the virtual buffer fullness;
means for controlling the quantization-step at the slice level; and
means for computing a variable panic level according to a number of remaining slices to be coded.

28. The apparatus of claim 27 at the picture level including at least one VBV Update module;
at least one Potential Overflow Check module;
a Decrease Virtual Buffer Fullness and Increase Bit Allocation module;
a Decrease Bit Allocation module;
an Increase Quantization Range module; and
a Modify quantization Matrices and Decrease Virtual Buffer-Fullness module.

29. The apparatus of claim 27 at the slice level including:
a VBV Estimation module;
a VBV Update module;
a Potential Overflow Check module;
a Potential Underflow Check module;
a Decrease Virtual Buffer-Fullness module;
an Increase Virtual Buffer-Fullness module;
a Set Panic Mode Coding module; and
an Encode a Slice module.

30. The apparatus of claim 27 wherein the video encoder is an MPEG-2 encoder.

31. The apparatus of claim 27 wherein slice level control is used in place of macroblock level control.

32. A method comprising:
encoding a set of macroblocks of video data, a plurality of macroblocks being in the set;
performing overflow control of the video data for a video buffer at a level of the set of macroblocks;
performing underflow control of the video data for the video buffer by implementing a variable panic level at the level of the set of macroblocks, the variable panic level varying according to a number of remaining sets of macroblocks to be encoded after the just encoded set;
performing picture-level overflow control of the video buffer;
performing picture-level underflow control of the video buffer; and
selectively increasing sensitivity of a Q-step by using a virtual buffer fullness control.

33. The method of claim 32, further comprising selectively increasing range of the Q-step by using a quantization step range control.

34. The method of claim 32 wherein the video buffer is a virtual video buffer.

35. The method of claim 32 wherein the performing picture-level overflow control of the video buffer is performed by using the virtual buffer fullness control, and the performing picture-level underflow control of the video buffer is performed using the virtual buffer fullness control.

36. The method of claim 35 wherein the encoding a series of macroblocks at a constant bit-rate coding, and further comprising:
at the picture-level:
increasing sensitivity for overflow prediction by incorporating a factor dependent on the encoding bit-rate; and
reducing the virtual buffer fullness when a factor extra-bits is greater than zero.

37. The method of claim 32 wherein the performing overflow control of the video data for a video buffer at a level of a set of macroblocks is performed using the virtual buffer fullness control, and the performing underflow control of the video data for the video buffer by implementing a variable panic level at the level of a set of macroblocks is performed using the virtual buffer fullness control.

38. The method of claim 37 wherein the encoding a series of macroblocks at a constant bit-rate coding, and further comprising:
at the level of a set of macroblocks:
estimating buffer-fullness in each set; and
reducing the virtual buffer-fullness if required.
